(19) United States
(12) Patent Application Publication
(10) Pub. No.: US 2024/0199456 A1
(43) Pub. Date: Jun. 20, 2024

(54) CO-DEACIDIFICATION AND DECHLORINATION OF AQUEOUS/GASEOUS STREAMS BY MINERAL DISSOLUTION

(71) Applicant: The Regents of the University of California, Oakland, CA (US)

(72) Inventors: Gaurav Sant, Los Angeles, CA (US); Xin Chen, Los Angeles, CA (US); Dante Simonetti, Los Angeles, CA (US); Steven Bustillos, Los Angeles, CA (US); David Jassby, Los Angeles, CA (US)

(21) Appl. No.: 18/511,368

(22) Filed: Nov. 16, 2023

Related U.S. Application Data
(60) Provisional application No. 63/427,027, filed on Nov. 21, 2022.

(51) Int. Cl. C02F 1/66

(52) U.S. Cl. CPC C02F 1/66; C02F 2101/12

(57) ABSTRACT

The present disclosure describes methods of deacidifying and dechlorinating an aqueous solution using a deacidifying and dechlorinating composition. The present methods advantageously produce a dechlorinated brine solution have a neutral to alkaline pH.

### CROSS REFERENCE TO RELATED APPLICATIONS

This application claims the benefit of priority to U.S. Provisional Application No. 63/427,027, filed Nov. 21, 2022, the contents of which are herein incorporated by reference in their entirety.

### STATEMENT REGARDING FEDERALLY SPONSORED RESEARCH

This invention was made with government support under Grant Number DE-FE0031705 awarded by the Department of Energy. The government has certain rights in the invention.

### BACKGROUND

Electrolytic technologies have been intensively exploited over the years due to their critical roles in renewable energy conversion and storage, acid and alkali productions, and CO₂ sequestration. However, electrolysis of aqueous solutions with high chlorine (Cl−) concentrations (e.g., seawater) may enrich electrolyte/gas stream(s) (e.g., anolyte effluents) with free-chlorine species (Cl₂, Clo⁻, HClO, etc.) and acidity (i.e., low in pH). If such enrichment of free-chlorine species and acidity is unintended, for instance, unlike the production of Cl₂ gas in the chlor-alkali processes, the acidic and chlorinated electrolyte/gas streams can be difficult to transfer and store, and are unsafe for disposal. Deacidification processes can be cost-intensive, using industry-standard alkalis such as Mg(OH)₂, NaOH, Ca(OH)₂ (about $100-500/ton). Moreover, dechlorination is an additional stand-alone treatment conducted with carbon-intensive materials, e.g., activated carbon (AC), which is a material having a high carbon footprint (>6 kg CO₂/kg AC)⁶. Accordingly, there is a need for simple and cost-effective methods for simultaneously deacidifying and dechlorinating of aqueous streams to produce dechlorinated brine solutions with neutral or alkaline pH.

### SUMMARY OF THE INVENTION

The present invention provides a method of deacidifying and dechlorinating an aqueous solution, wherein the method comprises contacting an aqueous solution with a deacidifying and dechlorinating composition, wherein the deacidifying and solid dechlorinating composition comprises a reductive species, and wherein the aqueous solution is an acidic solution comprising a free-chlorine species.

In some embodiments, the reductive species comprises a low valent metal. For example, the low valent metal may be in the form of a silicate, a carbonate, an oxide, a hydroxide, an oxyhydroxide, or any combination thereof. In some embodiments, the low valent metal comprises a group 3-12 element, preferably Fe⁰, Fe²⁺, Mn⁰, Mn³⁺, Mn⁴⁺, Ni⁰, Ni⁺, or any combination thereof.

In some embodiments, the deacidifying and dechlorinating composition comprises mafic and ultramafic minerals, such as olivine, serpentine, basalt, or a combination thereof.

The present methods advantageously provide aqueous solutions, such as aqueous brine solutions, having a reduced amount of a chlorine and a neutral to alkaline pH.

### BRIEF DESCRIPTION OF THE DRAWINGS

FIG. 1A depicts a strategic scheme showing the co-deacidification and dechlorination of an aqueous solution by dissolution of rocks containing carbonate and silicate minerals such as mafic and ultramafic minerals (such as olivine, serpentine, and basalt).

FIG. 1B shows the deacidification capacity of a reactor filled with the natural olivine rock in accordance with certain embodiments of the invention

FIG. 1C shows the dechlorination capacity of a reactor filled with the natural olivine rock in accordance with certain embodiments of the invention.

FIGS. 2A-2B show batch equilibrium experiments displaying the effect of solid loading on chlorine concentrations in solution for granulated activated carbon, copper slag, bituminous and anthracite coals, biochar and forsterite using an acidified seawater composition (initial pH 2) with 100-5000 OCl⁻ ppm initial concentrations.

FIG. 2C shows quantified OCl⁻ removal equilibrium capacities as a function of equilibrium OCl⁻ concentrations for granulated activated carbon, copper slag, bituminous and anthracite coals, biochar and forsterite.

### DETAILED DESCRIPTION OF THE INVENTION

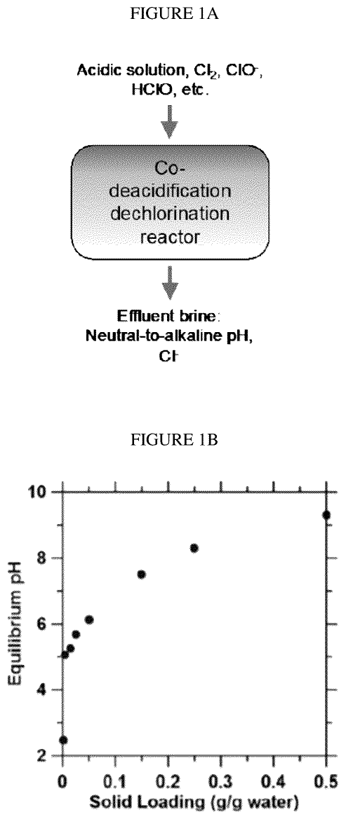

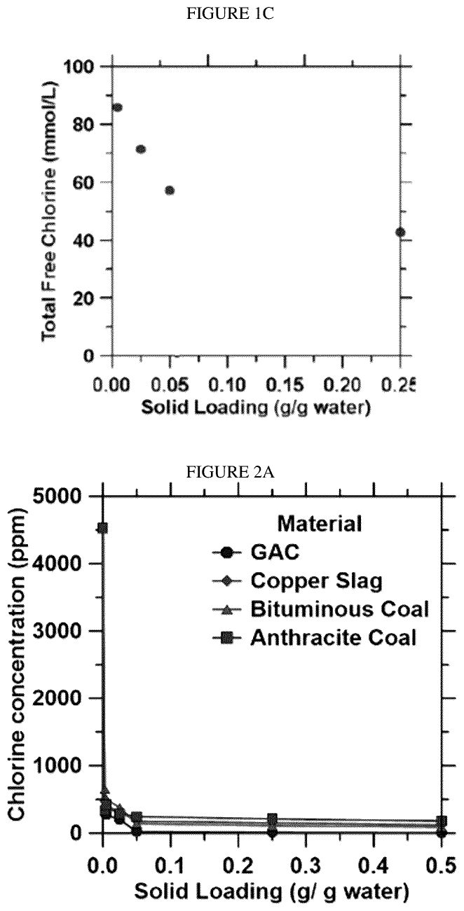

A simplified exemplary process is illustrated in FIG. 1A. As shown, the acidic and chlorinated flows are directed to a (batch or flow-through) reactor filled with alkaline rocks and minerals containing carbonates, hydroxides, oxides, and silicates, or mixtures thereof. In preferred embodiments, the filling rocks contain reductive species, such as low-valent metal elements (e.g., Fe⁰, Fe²⁺, Mn⁰, Mn³⁺, Mn⁴⁺, Ni⁰, Ni⁺, Ni³⁺, etc.) to permit the dechlorination capacity of the reactor. Thus, free-chlorine species can be reduced (Cl₂, ClO⁻, HClO, etc.) to chlorides (Cl⁻) by the reductive metals. Herein, we have demonstrated the deacidification and dechlorination capability of the proposed process, using a reactor filled with an olivine rock (for example, a composition as measured by X-ray fluorescence:(Mg_{0.45}, Fe_{0.05}, Mn_{0.0006}, Al_{0.009}, Ti_{0.0003}, Ca_{0.007}, Cr_{0.004}, Ni_{0.002}, C_{00.0001})₂SiO₄). An acidic brine solution (0.5 M NaCl+HCl, pH 2) was processed by the reactor, and Figure B shows the equilibrium pH of the effluent ranges from 5 to 9.5 at various solid loadings, suggesting the acid was effectively neutralized via the silicate dissolution: 4H⁺+[SiO₄]⁴⁻→H₄SiO₄. FIG. 1C shows the dechlorination capability of the reactor, processing a chlorinated brine solution (0.5 M NaCl+0.1M NaClO, pH 4.5). The hypochlorite ions (ClO⁻), which are the common free-chlorine species resulting from the water chlorination reaction: Cl₂+H₂O→ClO⁻+Cl⁻+2H⁺, can be effectively reduced by the reductive metals presented in the selected olivine rock (e.g., via the reaction of Fe²⁺+ClO⁻+2H⁺→Fe³⁺+Cl⁻+H₂O, and 2Fe²⁺+Cl₂→2Fe³⁺+2Cl⁻), thereby providing deacidified and dechlorinated effluents. In certain embodiments, the oxidized metal species (e.g., Fe³⁺) can be precipitated as a solid at elevated pH (e.g., in the form of an oxide, hydroxide, oxyhydroxide, or combination thereof).

The deacidification and dechlorination capacity may vary with the rock composition. For olivine rock used in certain embodiments herein, the deacidification capacity is about 20-30 mol of H⁺/kg, which is comparable to that of the NaOH (25 mol of H⁺/kg), but at significantly lower cost (i.e., the price of olivine rocks can be as low as $6.5/ton⁷). Meanwhile, the Fe²⁺-containing olivine rock has a chlorine uptake capacity of about 0.05-0.4 mol/kg, provides co-dechlorination capability and avoids the usage of activated carbon.

In certain aspects, provided herein are methods of deacidifying and dechlorinating an aqueous solution, wherein the method comprises contacting an acidic aqueous solution comprising a free-chlorine species with a deacidifying and dechlorinating composition, wherein the deacidifying and dechlorinating composition comprises a reductive species.

In certain embodiments, the reductive species comprises a low valent metal. In certain such embodiments, the low valent metal is in the form of a silicate, a carbonate, an oxide, a hydroxide, an oxyhydroxide, or any combination thereof. In certain embodiments, the low valent metal is in the form of a silicate. In some embodiments, the low valent metal is in the form of an oxide. In other embodiments, the low valent metal is in the form of a hydroxide. In certain embodiments, the low valent metal is in the form of an oxyhydroxide. In certain embodiments, the low valent metal is in the form of a carbonate. In some embodiments, the low valent metal is in the form of a combination of a silicate, an oxide, a hydroxide, a carbonate, and an oxyhydroxide.

In some embodiments, the low valent metal comprises a group 3-12 element. In certain such embodiments, the low valent metal comprises Fe⁰, Fe²⁺, Mn⁰, Mn³⁺, Mn⁴⁺, Ni⁰, Ni⁺, or any combination thereof. In some embodiments, the low valent metal is Fe⁰. In certain embodiments, the low valent metal is Fe²⁺. In other embodiments, the low valent metal is Mn⁰. In certain embodiments, the low valent metal is Mn³⁺. In some embodiments, the low valent metal is Mn⁴⁺. In certain embodiments, the low valent metal is Ni⁰. In some embodiments, the low valent metal is Ni⁺. In certain embodiments, the low valent metal comprises a combination of species selected from Fe⁰, Fe²⁺, Mn⁰, Mn³⁺, Mn⁴⁺, Ni⁰, and Ni⁺.

In certain embodiments, the deacidifying and dechlorinating composition further comprises a group I or group II metal carbonate, hydroxide, oxide, silicate, or any combination thereof.

In some embodiments, the deacidifying and dechlorinating composition comprises a mafic mineral, an ultramafic mineral, or both.

In certain preferred embodiments, the deacidifying and dechlorinating composition is a solid. In certain such embodiments, methods of the disclosure further comprise milling, grinding, or crushing the solid. In further embodiments, the solid as used in the deacidifying and dechlorinating method has a particle size in a range of about 100 nm to about 10 mm.

In some embodiments, the deacidifying and dechlorinating composition further comprises a silicate. In certain embodiments, the deacidifying and dechlorinating composition comprises olivine, serpentine, basalt, or any combination thereof. In certain preferred embodiments, the deacidifying and dechlorinating composition comprises olivine rock. In some embodiments, the deacidifying and dechlorinating composition comprises serpentine. In certain embodiments, the deacidifying and dechlorinating composition comprises basalt. In some embodiments, the deacidifying and dechlorinating composition comprises a combination of olivine, serpentine, and basalt.

In certain preferred embodiments, the deacidifying and dechlorinating composition has an elemental composition of the formula: (MgₐFe_{b}Mn_{c}Al_{d}TiₑCa_{f}Cr_{g}NiₕCoᵢ)₂SiO₄;
wherein;
   a is from about 0.4 to about 0.5;
   b is from about 0.01 to about 0.1;
   c is from about 0.0001 to about 0.001;
   d is from about 0.001 to about 0.01;
   e is from about 0.0001 to about 0.001;
   f is from about 0.001 to about 0.01;
   g is from about 0.001 to 0.01;
   h is from about 0.001 to about 0.01; and
   i is from about 0.00001 to about 0.001.

In some preferred embodiments, the deacidifying and dechlorinating composition has an elemental composition of the formula: (MgₐFe_{b}Mn_{c}Al_{d}TiₑCa_{f}Cr_{g}NiₕCoᵢ)₂SiO₄;
wherein:
   a is about 0.45;
   b is about 0.05;
   c is about 0.0006;
   d is about 0.009;
   e is about 0.0003;
   f is about 0.007;
   g is about 0.004;
   h is about 0.002; and
   i is about 0.0001.

In certain embodiments, the deacidifying and dechlorinating composition has a deacidification capacity of from about 1 to 100 moles of H⁺ per kilogram of deacidifying and dechlorinating composition. In some preferred embodiments, the deacidifying and dechlorinating composition has a deacidification capacity of about 100 moles of H⁺ per kilogram of deacidifying and dechlorinating composition. In certain embodiments, the deacidifying and dechlorinating composition has a deacidification capacity of about 85 moles of H⁺ per kilogram of deacidifying and dechlorinating composition. In some embodiments, the deacidifying and dechlorinating composition has a deacidification capacity of about 60 moles of H⁺ per kilogram of deacidifying and dechlorinating composition. In certain embodiments, the deacidifying and dechlorinating composition has a deacidification capacity of about 45 moles of H⁺ per kilogram of deacidifying and dechlorinating composition. In some embodiments, the deacidifying and dechlorinating composition has a deacidification capacity of about 30 moles of H⁺ per kilogram of deacidifying and dechlorinating composition. In certain embodiments, the deacidifying and dechlorinating composition has a deacidification capacity of about 15 moles of H⁺ per kilogram of deacidifying and dechlorinating composition. In some embodiments, the deacidifying and dechlorinating composition has a deacidification capacity of about 1 mole of H⁺ per kilogram of deacidifying and dechlorinating composition.

In certain embodiments, the method is carried out in a batch reactor. In other embodiments, the method is carried out in a continuous flow reactor.

In some embodiments, the deacidifying and dechlorinating composition and the aqueous solution have a ratio of from about 0.000001 g/mL to about 1000000 g/mL, about 0.00001 g/mL to about 100 g/mL, about 0.0001 g/mL to about 10 g/mL, or about 0.0001 g/mL to about 2 g/mL.

In certain embodiments, contacting the deacidifying and dechlorinating composition and the aqueous solution further comprises mixing, stirring, or agitating the solution for a period of time.

In some embodiments, the period of time is from about 10 seconds to about 48 hours.

In certain embodiments, the aqueous solution is the product of an electrolysis process.

In some embodiments, the method does not comprise contacting the solution with activated carbon or coal.

In certain embodiments, the chlorine species comprises Cl₂, ClO⁻, HClO, or any combination thereof. In some such embodiments, the chlorine species is Cl₂. In certain embodiments, the chlorine species is ClO⁻. In some embodiments, the chlorine species is HClO.

In some embodiments, the aqueous solution has a pH of less than about 5. In certain embodiments, the aqueous solution has a pH in a range of about 0 to 3.

In certain embodiments, the method produces a dechlorinated aqueous solution having neutral-to-alkaline pH. In some embodiments, the dechlorinated aqueous solution has a pH of greater than about 4. In certain embodiments, the dechlorinated aqueous solution has a pH in a range of about 4-9.

In some embodiments, the total free chlorine in the dechlorinated brine solution is less than about 100 ppm. In certain embodiments, the total free chlorine in the dechlorinated brine solution is from 0 ppm to about 100 ppm.

### Definitions

Unless otherwise defined herein, scientific and technical terms used in this application shall have the meanings that are commonly understood by those of ordinary skill in the art. Generally, nomenclature used in connection with, and techniques of, chemistry, chemical engineering, electrical engineering and civil engineering described herein, are those well-known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C. A. (1985).

All publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not. For example, “optionally milling the solid” refers to embodiments wherein the solid can be used as—is or the solid can be milled to finer particle sizes for use.

The terms “olivine” and “olivine rock” as used herein may refer to at least one of olivine, comprising Mg, Fe, and SiO₄, and any of the various members of the “Olivine Group,” which includes olivine, tephroite, monticellite, larnite and kirschsteinite. The above olivine species may further comprise other elements, such as, Mg, Fe, Mn, Al, Ti, Ca, Cr, Ni, Co. Olivine may be found in mafic and ultramafic igneous rock.

The terms “deacidifying,” “deacidify,” and “deacidification” as used herein refer to a process that results in an increase in pH of an aqueous solution.

A “deacidifying composition” herein refers to a composition that deacidifies a substrate. Deacidifying compositions include alkaline rocks and minerals containing carbonates, hydroxides, oxides, and/or silicates. As a non-limiting example, olivine rock may, in certain embodiments, be used as a deacidifying composition to deacidify a solution with a low pH.

“Free-chlorine species” as used herein may refer to any chemical compound that comprises or can generate chlorine atoms with an oxidation state greater than or equal to 0. As non-limiting examples, free-chlorine species of the disclosure include Cl₂, ClO⁻, and HClO. The terms “dechlorinate,” and “dechlorination” as used herein refer to processes that result in the removal of Cl-containing compounds or ions from a substrate such as an aqueous solution. In preferred embodiments, as a non-limiting example, dechlorination includes the chemical conversion of free-chlorine species (e.g., Cl₂, ClO⁻, HClO, etc.) to chlorides (Cl⁻) using a dechlorinating composition.

The term “dechlorinating composition” as used herein refers to a composition that facilitates the chemical transformation of free-chlorine species into chlorides.

The term “deacidifying and dechlorinating composition” as used here refers to a composition that advantageously deacidifies (e.g., induces an increase in pH of an aqueous solution and dechlorinates (e.g., facilitates the chemical transformation of free-chlorine species into chlorides) an aqueous solution.

The term “reductive species” as used herein refers to a chemical species which may interact with another chemical species and transfer at least one valence electron to the chemical species, thereby reducing the chemical species. Reductive species may include, but are not limited to, low-valent metallic species.

The term “low-valent metallic species” as used herein refers to chemical species, which exists in a formal oxidation state less than (i.e., lower than) at least one of the most common naturally-occurring non-zero oxidation states. As non-limiting examples, low-valent metal species described herein may include Fe⁰, Fe²⁺, Mn⁰, Mn³⁺, Mn⁴⁺, Ni⁰, Ni⁺, and Ni³⁺.

### EXAMPLES

The invention now being generally described, it will be more readily understood by reference to the following examples which are included merely for purposes of illustration of certain aspects and embodiments of the present invention, and are not intended to limit the invention.

### Example 1: Batch Equilibrium Chlorine Reduction Experiments

Instant Ocean™ Sea Salt, 6% (w/w) sodium hypochlorite solution (NaOCl), 37% (w/w) hydrochloric acid (HCl) and 70% (w/w) nitric acid (HNO₃) were all purchased from Fisher Scientific. Ward's Olivine (Jackson, North Carolina), copper slag (Blast Coat Systems), Wakefield Biochar and granulated activated carbon (McMaster-Carr) were used for batch equilibrium and fixed-bed chlorine reduction experiments. Olivine samples were initially crushed to mm grains using an automatic rock crusher and further grinded with a milling ball machine. The particles produced by this step were dry sieved adhering to the 75<d<150 um size fractions.

Powder X-Ray diffraction (XRD) patterns of the precipitated phases were obtained on an X-Ray diffractometer (Panalytical X'Pert Pro X-Ray Powder Diffractometer) using Cu Kα radiation of 1.5410 Å to identify the mineral phases of the solids. X-ray fluorescence was used to estimate the bulk oxide composition of the powder based on the Fusion Method ASTM D4326 (2004) using the Bruker S8 Tiger WDXRF instrument. Particle size distributions were measured using static light scattering (SLS; LS13-320, Beckman Coulter Static Light Scattering) with water and sonication being used to ensure particle dispersion. Bulk porosities and densities were measured using helium pycnometry (AccuPyc II 1340, Micromeritics) after drying the materials at 65° C. for 3 h.

Chlorine reduction experiments using synthetic acidified seawater solutions (pH 2, 1-7000 ppm Cl₂) were performed to quantify the extent of chlorine reduction and to quantify chlorine reduction capacities of these solids. Synthetic acidified seawater solutions (pH 2) with 1, 10, 100, 1000, 2500, 5000 and 7000 ppm Cl₂ were prepared in ultra-pure water (18.2 MΩ cm⁻¹) by diluting 6% (w/w) NaOCl, 37% (w/w) hydrochloric acid and mixing Instant Ocean™ Sea Salt to achieve the desired pH and chlorine concentration. All experiments were performed at a solid/liquid ratio of 0.003 g/mL at 25° C. unless otherwise stated. All batch equilibrium experiments were performed using tightly sealed conical centrifuge tubes of equal dimensions and shaken continuously using a Corning LSE orbital shaker for 48 hours. Solutions from all batch equilibrium experiments were sampled at 30, 60, 120, 180 min, and at the 24- and 48-hour marks for total chlorine and cation concentration analysis. A DR1900 portable spectrophotometer and Hach TNT867 total free chlorine test kits were used to analyze free chlorine concentrations in solution, both purchased from Hach, to ensure that equilibrium was achieved. Cation concentration analysis was performed by inductively coupled plasma-optical emission spectroscopy (ICP-OES; Avio 200 ICP Optical Emission Spectrometer, Perkin Elmer) to ensure that equilibrium was achieved.

Equilibrium was established when the chlorine concentrations in solution were invariant with time. Chlorine reduction capacities (q_{Cl2}; g CL₂ per gram of solid; eq. 1) were calculated by

$${q}_{cl 2} = \frac{( {C}_{0} - {C}_{f} ) \cdot V}{W} \qquad ( 1 )$$

where C_{f} and C₀ are final and initial chlorine concentrations in solution, respectively, V is the solution volume, and W is the mass of solid.

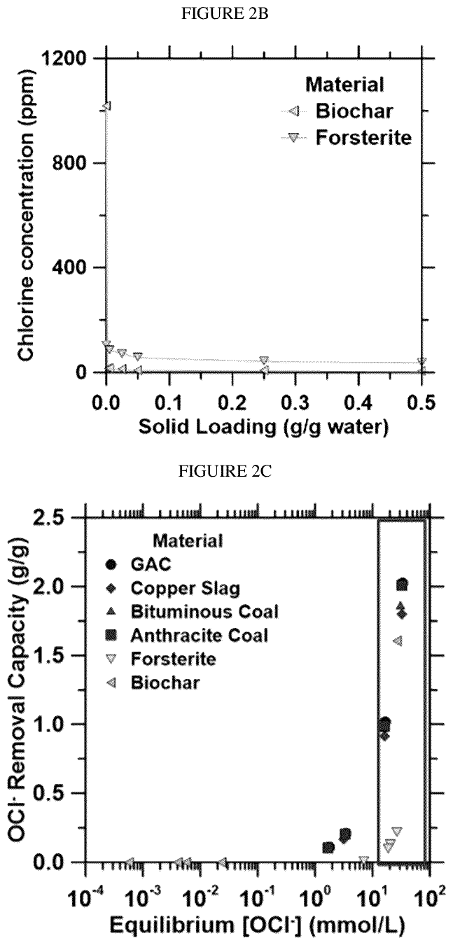

To demonstrate the feasibility of chlorine reduction using carbon-rich and ferrous-rich materials previously described, increasing amounts of these solids were added to 20 ml of synthetic acidified seawater with up to an initial ˜4700 ppm OCl⁻ concentrations. As seen in FIGS. 2A-2B, Maximum chlorine reduction was achieved using GAC (>99% chlorine reduction) at a solid loading of 0.05 g/g seawater. Similarly, >90% chlorine reduction is achieved using copper slag, bituminous and anthracite coals, and biochar at solid loadings of 0.05 g/g seawater for each material. On the other hand, forsterite was able to reduce chlorine in solution by 45% at a solid loading of 0.05 g/g seawater. To further quantify the chlorine removal capacities at equilibrium concentrations similar—to those expected from the anode stream (e.g., 100-5000 OCl⁻ ppm), chlorine removal isotherms were collected using the same acidified synthetic seawater composition. Highlighted in FIG. 1C, chlorine removal capacities range from 0.30-2.2 g OCl⁻ per g solid using granulated activated carbon (GAC), copper slag, bituminous and anthracite coals, forsterite, and biochar. GAC, copper slag, biochar and both coals studied displayed the highest chlorine removal capacities suitable for the process. These data demonstrate the ability of these materials to sufficiently remove chlorine from acidified seawater solutions (e.g., <1 ppm OCl⁻).

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A method of deacidifying and dechlorinating an aqueous solution, wherein the method comprises contacting an acidic aqueous solution comprising a free-chlorine species with a deacidifying and dechlorinating composition, wherein the deacidifying and dechlorinating composition comprises a reductive species.

2. The method of claim 1, wherein the reductive species comprises a low valent metal.

3. The method of claim 2, wherein the low valent metal is in the form of a silicate, a carbonate, an oxide, a hydroxide, an oxyhydroxide, or any combination thereof.

4-9. (canceled)

10. The method of claim 2, wherein the low valent metal comprises a group 3-12-element.

11. The method of claim 3, wherein the low valent metal comprises Fe⁰, Fe²⁺, Mn⁰, Mn³⁺, Mn⁴⁺, Ni⁰, Ni⁺, or any combination thereof.

12-19. (canceled)

20. The method of claim 1, wherein the deacidifying and dechlorinating composition further comprises a group I or group II metal carbonate, hydroxide, oxide, silicate, or any combination thereof.

21. The method of claim 1, wherein the deacidifying and dechlorinating composition comprises a mafic mineral, an ultramafic mineral, or both.

22. The method of claim 1, wherein the deacidifying and dechlorinating composition is a solid, and the solid has a particle size in a range of about 100 nm to about 10 mm.

23. (canceled)

24. (canceled)

25. The method of claim 1, wherein the deacidifying and dechlorinating composition further comprises a silicate.

26. The method of claim 1, wherein the deacidifying and dechlorinating composition comprises olivine, serpentine, basalt, or any combination thereof.

27-30. (canceled)

31. The method of claim 1, wherein the deacidifying and dechlorinating composition has an elemental composition of the formula:
(MgₐFe_{b}Mn_{c}Al_{d}TiₑCa_{f}Cr_{g}NiₕCoᵢ)₂SiO₄;
wherein;
a is from about 0.4 to about 0.5;
b is from about 0.01 to about 0.1;
c is from about 0.0001 to about 0.001;
d is from about 0.001 to about 0.01;
e is from about 0.0001 to about 0.001;
f is from about 0.001 to about 0.01;
g is from about 0.001 to 0.01;
h is from about 0.001 to about 0.01; and
i is from about 0.00001 to about 0.001.

32. (canceled)

33. The method of claim 1, wherein the deacidifying and dechlorinating composition has a deacidification capacity of from about 1 to 100 moles of H⁺ per kilogram of deacidifying and dechlorinating composition.

34-40. (canceled)

41. The method of claim 1, wherein the deacidifying and dechlorinating composition has a chlorine uptake capacity of from about 0.01 to about 10 moles of chlorine per kilogram of dechlorinating composition.

42-49. (canceled)

50. The method of claim 1, wherein the deacidifying and dechlorinating composition and the aqueous solution have a ratio of from about 0.000001 g/mL to about 1000000 g/mL, about 0.00001 g/mL to about 100 g/mL, about 0.0001 g/mL to about 10 g/mL, or about 0.0001 g/mL to about 2 g/mL.

51-53. (canceled)

54. The method of claim 1, wherein the method does not comprise contacting the solution with activated carbon or coal.

55. The method of claim 1, wherein the chlorine species comprises Cl₂, ClO⁻, HClO, or any combination thereof.

56. The method of claim 1, wherein the aqueous solution has a pH of less than about 5.

57. (canceled)

58. The method of claim 1, wherein the method produces a dechlorinated aqueous solution having neutral-to-alkaline pH.

59. The method of claim 58, wherein the dechlorinated aqueous solution has a pH of greater than about 4.

60. (canceled)

61. The method of claim 58, wherein the total free chlorine in the dechlorinated aqueous solution is less than about 100 ppm.

62. (canceled)
